(19) United States
(12) Patent Application Publication
(10) Pub. No.: US 2004/0091603 A1
(43) Pub. Date: May 13, 2004

(54) Process for the preparation of a medical implant

(76) Inventor: Jorg Priewe, Sophienblatt, FL (US)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/467,892

(22) PCT Filed: Jan. 7, 2002
(86) PCT No.: PCT/EP02/00068

(30) Foreign Application Priority Data
Feb. 13, 2001 (DE) 101065469

(51) Int. Cl. B05D 3/00

(52) U.S. Cl. 427/2.24

(57) ABSTRACT

In a process for the preparation of a medical implant which has a porous e.g. polymer-based basic structure, and at least one hydrogel element containing polyethylene oxide and/or polyethylene glycol, an aqueous solution, aqueous liquid mixture or melt which contains polyethylene oxide and/or polyethylene glycol, is applied at least regionally to the basic structure. A cross linking is carried out by irradiation with gamma rays to produce a hydrophilic hydrogel.

The invention relates to a process for the preparation of a medical implant which has a porous basic structure and at least one hydrogel element.

Porous implants are widely used in medicine, e.g. as meshes for repairing abdominal wall defects such as hernias, as tapes in the holding function for treating stress incontinence or as stents. In many cases, such implants have a flexible, polymer-based basic structure, but metals can also be considered as materials (e.g. for stents).

Frequently-used materials such as polypropylene, polyvinylidene fluoride, polytetrafluoroethylene, polyethylene, polyetherester and others are characterized in that they are chemically relatively inert but offer no simple possibilities to modify the surface, as there are either no reactive groups or the surfaces are too smooth for long-term stabile coatings. Furthermore attempts to modify the surface can result in the properties of the basic structure of the polymer material changing considerably (e.g. through temperature shrinkage or solvent effects) so that it is questionable whether the basic structure still performs as well in terms of its mechanical properties as the original material which has often been optimized and known for years.

However, these implantable polymers have undesired properties for some uses. They can lead to calcination, to tissue reactions, to adhesion with internal organs, to cell proliferation (e.g. in the case of polymer stents, but also metal stents) or simply to mechanical stress and thus damage to neighbouring tissues.

Polyethylene glycols (PEGs) and polyethylene oxides (PEOs) have already been known for a long time in the cosmetics, medical and pharmaceutical industries and are characterized by good biocompatibility, low immunogenicity and above all by anti-adhesive behaviour. For example, PEG-modified liposomes are used as active ingredient carriers, since the low plasma protein adsorption on such vesicles prevents the particles' being recognised and opsonized by the immune system. The use of these properties also for biomaterials has thus already been attempted for some time. Firstly functional groups are mostly produced e.g. OH groups via permanganate/sulphuric acid which can then be reacted with PEG epoxides. Or attempts are made even beforehand to couple polyamines on the previously oxidized surfaces (Bergstrom et al., pp. 195-204 in Polymer Biomaterials in Solution as Interfaces and as Solids, Eds: Cooper, Bamford, Tsuruta, VSP BV 1995 Utrecht) in order to then couple PEG or PEO. In any case, these processes are relatively expensive, require costly syntheses of reactive coupling polymers or their purchase, several syntheses and cleaning stages and a coupling on the previously functionalized implant.

Similarly, gas-permeable implants are known from WO 91/15952 in which functional amine groups are bound to a siloxane surface by plasma etching in ammonia. The amine groups carry PEO chains via covalent bonds. Bioactive molecules are coupled to the PEO chains.

EP 0 103 290 describes solutions of short-chained polyethylene glycols and polypropylene glycols and their copolymers with a molecular weight smaller than 20,000 which can prevent growths in the stomach area. Shaped bodies are disclosed which are prepared by chemical cross-linking of gelatine with formaldehyde. Cross-linked gelatine is not however suitable for the preparation of long-term stable shaped bodies as it is degraded.

A gel which can be injected into a patient is known from. U.S. Pat. No. 5,634,943 which can serve as tissue replacement. The gel is prepared by dissolving polyethylene oxide in a salt solution, gassing it with argon and subjecting it to a gamma irradiation in order to cross-link the polymer and sterilize it at the same time.

The object of the invention is to provide an easily applicable process for the preparation of a medical implant which has a porous basic structure and at least one hydrogel element. The proven basic structure of the implant and its mechanical properties are to be at least largely retained, without the need to use auxiliaries such as polymerisation starters, primers or oxidation agents for surface pre-treatment.

This object is achieved by a process with the features of claim 1. Advantageous designs of the invention result from the dependent claims.

The medical implant manufactured with the process according to the invention has a porous basic structure and at least one hydrogel element which contains polyethylene oxide (PEO) and/or polyethylene glycol (PEG). The basic structure is preferably flexible. During the process, an aqueous solution, aqueous liquid mixture or melt, which contains polyethylene oxide and/or polyethylene glycol, is applied to the basic structure at least in one or more areas (e.g. by coating or immersion), and a cross-linking is carried out by irradiation with gamma rays to produce a hydrophilic hydrogel. In particular, an at least partial coating of the basic structure or a shaped body attached to the basic structure can be considered as hydrogel element. In the latter case, the shaped body is preferably attached by at least partial embedding of an area of the basic structure in the shaped body.

The basic structure preferably contains polymers, metals, inorganic glasses and/or inorganic ceramics. Polymer-based implants have already been mentioned. Inorganic glasses and ceramics can be present in the basic structure e.g. as flexible fibres. Stents are often prepared with metal basic structures which are preferably flexible, but can also be deformed in the plastic area.

Surprisingly it has been shown that, with the process according to the invention, biocompatible, long-term stable PEO or PEG hydrogel shaped bodies or coatings can even be applied to radiation-sensitive polymers such as e.g. meshes made from polypropylene, which endow the implant with completely new properties without the mechanical properties of the basic structure, such as tensile strength or elasticity, being greatly changed. Thus, e.g. a single sterilization process by means of irradiation with gamma rays in a cobalt-60-apparatus is sufficient to produce a stable biocompatible polyethylene oxide hydrogel without noticeably damaging a polypropylene tape which is known to be sensitive to gamma rays. A protective-gas atmosphere is not necessary for this.

A particular advantage of the process according to the invention is that the hydrogel elements can as a rule be applied to the basic structure without additional treatment or surface modification of the basic structure. As the hydrogel elements are cross-liked when they are located on the basic structure, the respective hydrogel element is as a rule mechanically connected to or meshed with the basic structure. The process is therefore suitable for a large number of types of materials for the basic structure with completely different surface properties.

In one version of the process, the aqueous solution, aqueous liquid mixture or melt containing polyethylene oxide and/or polyethylene glycol on the basic structure is at least partly enclosed in film before irradiation. The film thus serves as a type of mould and can be optionally removed after the irradiation, i.e. after the cross-linking of the hydrogel. Various forms are conceivable for the film. Thus the film can be non-resorbable (e.g. made from polyethylene or polypropylene) but can also resorbable (e.g. made from poly-p-dioxanone). While the film is preferably mechanically removed in the former case, it can be degraded in the latter case e.g. by hydrolysis, even after it has been implanted in the body of a patient.

It is possible, before the application of the aqueous solution, aqueous liquid mixture or melt containing polyethylene oxide and/or polyethylene glycol, to cover areas of the basic structure with an auxiliary coating which preferably contains a monomer, oligomer or polymer. The aqueous solution, aqueous liquid mixture or melt containing polyethylene oxide and/or polyethylene glycol is then preferably applied to an area of the basic structure which is free of the auxiliary coating. Thus e.g. the auxiliary coating can be so thick that no components for the hydrogel settle on the areas of the basic structure covered by the auxiliary coating upon immersion in an aqueous solution, aqueous liquid mixture or melt containing polyethylene oxide and/or polyethylene glycol, so that the basic structure is free from hydrogel elements at these points after the irradiation. The auxiliary coating can be removed after irradiation, preferably by alkaline hydrolysis, acid hydrolysis or the use of a solvent. It is also conceivable to apply an aqueous solution, aqueous liquid mixture or melt containing polyethylene oxide and/or polyethylene glycol via such an auxiliary coating; after the cross-linking and removal of the auxiliary coating, there is then a cavity between the hydrogel elements concerned and the basic structure or inside the hydrogel elements.

The aqueous solution, aqueous liquid mixture or melt preferably contains a polyethylene oxide and/or polyethylene glycol with a molecular weight greater than 20,000, preferably greater than 100,000 and particularly preferably greater than 1,000,000. As a rule, the smaller the energy dose of gamma ray required to cross-link the hydrogel element, the greater the molecular weight of the starting substances. As a result, a higher molecular weight results in a smaller radiation load for the material of the basic structure.

The energy dose during irradiation is preferably smaller than 100 kGy and can lie e.g. in the range of 20 kGy to 30 kGy. Thus for example the tensile strength of polypropylene, which is naturally rather radiation-sensitive, drops to only 60% of the starting value at an energy dose of 20 kGy to 30 kGy, such as is also used for sterilisation purpose. A basic structure made from polypropylene is thus not seriously damaged under such conditions. The irradiation can be carried out e.g. with ⁶⁰ co-gamma radiation.

At least one hydrogel element preferably contains at least one of the following substances (in addition to PEG and/or PEO): hydrophilic polymers, surfactants, saccharides, polysaccharides, polyvinyl alcohol, polyhydroxyethyl methacrylate, poly-n-isopropylacrylamide, polyvinylpyrrolidone. Such substances through which the properties of the hydrogel elements can be improved can be already introduced into the hydrogel elements e.g. via the aqueous solution, aqueous liquid mixture or melt containing polyethylene oxide and/or polyethylene glycol, before the cross-linking but also subsequently. Furthermore the hydrogel elements can contain substances such as resorbable hydrophobic polymers or polyhydroxy acids, polylactide, polyglycolide, polyhydroxy butyric acids, polydioxanones, polyhydroxy valeric acids, polyorthoesters, polyphosphazenes, poly-ε-caprolactones, polyphosphates, polyphosphonates, polyurethanes and/or polycyanoacrylates as well as mixtures and/or copolymers of the afore-mentioned substances. Such substances can already be introduced into the aqueous solution, aqueous liquid mixture or melt containing polyethylene oxide and/or polyethylene glycol e.g. in the form of particles before the cross-linking.

The implant can be dried in the air or in another gas, such as e.g. nitrogen or argon, by freeze-drying or by drying at the critical point.

The process of drying at the critical point is widespread in the preparation of samples for electro microscopy in order to carefully dry biological material, such as e.g. cells, while preserving the structure. To this end, firstly the water in the sample is replaced by a liquid which can be mixed with water and carbon dioxide, e.g. ethanol, methanol, amyl acetate or acetone. This liquid is then exchanged for liquid carbon dioxide. Carbon dioxide has a critical point with temperature and pressure conditions (approx. 31° C. and 74 bar respectively) which are easy to handle and sample-compatible. When the sample is dried at the critical point of carbon dioxide, the liquid carbon dioxide passes into the gaseous state practically without any increase in volume, thus in a manner that is very favourable for the sample.

Many basic shapes are conceivable for the basic structure of the implant, as already indicated. The basic structure can thus be designed e.g. as a mesh, tape, film strip, perforated film, circular-knitted hose, perforated tube, perforated pipe or stent (polymer stent, metal stent). The shape is based on the use of the implant, e.g. as a mesh for repairing hernias, as a tape for supporting the middle urethra, as a stent or as an artificial vessel.

The basic structure can include a non-resorbable or a slowly resorbable polymer, the basic structure preferably containing at least one polymer selected from the following group: polyacrylates, polymethacrylates, polyacrylamides, polyethylenes, polypropylenes, polyvinyl acetates, polyethylene-co-vinyl acetates, polyureas, polyesters, polyether esters, polyamides, polyimides; polyamino acids, pseudopolyamino acids, terephthalic acid-containing polyesters, partly fluorinated polyalkenes, perfluorinated polyalkenes, polyperfluoroethene, polyvinylidene fluoride, polycarbonates, polyarylether ketones. Copolymers or mixed forms are also conceivable. The basic structure can however also contain a resorbable polymer, e.g. polyhydroxy acids, polylactide, polyglycolide, polyhydroxy butyric acids, polydioxanones, polyhydroxy valeric acids, polyorthoesters, polyphosphazenes, poly-ε-caprolactones, polyphosphates, polyphosphonates, polyurethanes, polycyanoacrylates. Copolymers or mixtures are also possible here.

Preferred thicknesses for the hydrogel elements are in the range between 0.025 mm to 20 mm. The basic structure can be embedded e.g. at least in parts in at least one hydrogel element. In order to e.g. connect a hydrogel body to an implant mesh, it is also conceivable to include a basic structure designed as a mesh piece completely in hydrogel and then to sew it onto a conventional implant mesh.

Hydrogels which contain PEO or PEG have an anti-adhesive action. For an implant, this characteristic can be used particularly when a hydrogel element is designed at least partly as a coating of the basic structure.

With conventional stents, which contain an anti-adhesive or anti-proliferous coating, the problem often occurs that the coating comes off upon expansion of the stent. On the other hand, if the stent is coated with or enclosed in hydrogel using the process according to the invention, the hydrogel, because of its elasticity, adapts easily to the change in the surface upon expansion of the stent. The same applies to surgical polymer meshes which are subjected to particular mechanical stresses as regards bending and extension during and after implantation.

A hydrogel element which is designed as a shaped body attached to the basic structure is suitable e.g. for absorbing active ingredients. In a preferred version of the invention, at least one active ingredient (preferably selected from the following group: growth factors, cytostatics, antibiotics, hormones, heparin, growth inhibitors, antimycotics, antiphlogistics, gynaecological agents, urological agents) and/or at least one contrast agent (preferably selected from the following group: x-ray contrast agents, ultrasound contrast agents, near infra-red contrast agents, magnetic resonance contrast agents) is introduced into at least one hydrogel element. Depending on the active ingredient, this can optionally already take place before cross-linking, by adding the active ingredient concerned to the aqueous solution, aqueous liquid mixture or melt which contains polyethylene oxide and/or polyethylene glycol, or after the crosslinking of the hydrogel. Furthermore, e.g. a contrast agent can be included in a hydrogel element. It is also conceivable to design a hydrogel element in such a way that a contrast agent and/or an active ingredient is released from the hydrogel element in a controlled manner, e.g. according to a pre-set schedule after the implant is inserted in a patient, in order to thus develop a diagnostic or therapeutic action.

The following examples serve to further explain the invention.

### EXAMPLE 1

A 2% aqueous polyethylene oxide solution (Mw=2,000,000) was prepared. This was introduced into a cobalt-60 unit in a customary sterilisation process (irradiation with approx. 25 kGy). At the same time, a polypropylene tape enclosed in polyethylene film (TVT® from Ethicon GmbH) was irradiated as a control. After the irradiation, a stable hydrogen had formed. No noticeable damage was recognised to either the polypropylene tape or the polyethylene film (flexibility, tensile strength, colour).

### EXAMPLE 2

A 5% (w/w) aqueous polyethylene oxide solution (Mw=2,000,000) was prepared. The solution was introduced into a polyethylene tubular film which had a width of 1.3 cm when flat, was thermally sealed on one side and into which was placed a piece of polypropylene mesh which was approx 1.1 cm wide (length approx. 3 cm, made from TVT®, Ethicon GmbH). The open tube side was then likewise thermally sealed. The tube was introduced into an empty autoclavable glass vessel. After a customary sterilisation process in the cobalt-60 unit (approx. 25 kGy) the mesh strip was partly coated with hydrogel; at the same time a lot of free liquid was observed.

### EXAMPLE 3

A 2% (w/w) aqueous polyethylene oxide solution (Mw=2,000,000) was prepared and freed of oxygen for half an hour in the nitrogen stream. This solution was introduced into a polyethylene tubular film which had a width of 1.3 cm when flat, was thermally sealed on one side and into which was placed a piece of polypropylene mesh which was approx. 1.1 cm wide (length approx. 3 cm, made from TVT®, Ethicon GmbH). The open tube side was then likewise thermally sealed. The tube was introduced into an empty autoclavable glass vessel. After a customary sterilisation process in the cobalt-60 unit (approx. 25 kGy) the mesh strip was partly covered with hydrogel; at the same time a lot of free liquid was observed.

### EXAMPLE 4

A 2% (w/w) aqueous polyethylene oxide solution (Mw=2,000,000) was prepared and freed of oxygen for half an hour in the nitrogen stream. This solution was poured into a polyethylene tubular film which had a width of 1.3 cm when flat, was thermally sealed on one side and into which was placed a piece of polypropylene mesh which was approx. 1.1 cm wide (length approx. 3 cm, made from TVT® Ethicon GmbH). The open tube side was then likewise thermally sealed. The tube was introduced into an autoclavable glass vessel filled with 40 ml of water. After a customary sterilisation process in the cobalt-60 unit (approx. 25 kGy) the mesh strip was almost completely surrounded by hydrogel, there was hardly any free liquid. The gel layer had a thickness of approx. 3 mm.

### EXAMPLE 5

A 5% (w/w) aqueous polyethylene oxide solution (Mw=2,000,000) was prepared. This solution was poured into a polyethylene tubular film which had a width of 1.3 cm when flat, was thermally sealed on one side and into which was placed a piece of polypropylene mesh which was approx. 1.1 cm wide (length approx. 3 cm, made from TVT®, Ethicon GmbH). The open tube side was then likewise thermally sealed. The tube was introduced into an autoclavable glass vessel filled with 40 ml of water. After a customary sterilisation process in the colbat-60 unit (approx. 25 kGy) the mesh strip was almost completely surrounded by hydrogel, there was practically no free liquid.

### EXAMPLE 6

A 2% (w/w) aqueous polyethylene oxide solution (Mw=2,000,000) was prepared. This solution was introduced into a polyethylene tubular film which had a width of 1.3 cm when flat, was thermally sealed on one side and into which was placed a piece of polypropylene mesh which was approx. 1.1 cm wide (length approx. 3 cm, made from TVT®, Ethicon GmbH). The open tube side was then likewise thermally sealed. The tube was introduced into an autoclavable glass vessel filled with 40 ml of water. After a customary sterilisation process in the cobalt-60 unit (approx. 25 kGy), the mesh strip was almost completely surrounded by hydrogel, there was practically no free liquid.

### EXAMPLE 7

A 2% (w/w) aqueous polyethylene oxide solution (Mw=2,000,000) was prepared which additionally contained 20% of surfactant (“Pluronic F127”, BASF). The solution was poured cold into a polyethylene tubular film which had a width of 1.3 cm when flat, was thermally sealed on one side and into which was placed a piece of polypropylene mesh which was approx. 1.1 cm wide (length approx. 3 cm, made from TVT®, Ethicon GmbH). The open tube side was then likewise thermally sealed. The tube was introduced into an autoclavable glass vessel filled with 40 ml of water. After a customary sterilisation process in the colbalt-60 unit (approx. 25 kGy), the mesh strip was surrounded by hydrogel.

### EXAMPLE 8

A 2% (w/w) aqueous polyethylene oxide solution (Mw=2,000,000) was prepared. This solution was poured cold into a polyethylene tubular film which had a width of 1.3 cm when flat, was thermally sealed on one side and into which was placed a piece of partly resorbable mesh of Vy-pro®, Ethicon GmbH (composite mesh made from polyglycolide-co-lactide 90/10 and polypropylene), which was approx. 1.1 cm wide and about 3 cm long. The open tube side was then likewise thermally sealed. The tube was introduced into an autoclavable glass vessel filled with 40 ml water. After a customary sterilisation process in the colbalt-60 unit (approx. 25 kGy), the mesh strip was surrounded by hydrogel.

1. Process for manufacturing a medical implant which comprises a porous basic structure, which is preferably flexible, and at least one hydrogel element containing polyethylene oxide and/or polyethylene glycol, wherein an aqueous solution, aqueous liquid mixture or melt which contains polyethylene oxide and/or polyethylene glycol is applied at least regionally the basic structure, and a cross-linking to provide a hydrophilic hydrogel is carried out by irradiation with gamma rays.

2. Process according to claim 1, characterized in that the basic structure contains at least one of the materials selected from the following group: polymers, metals, inorganic glasses, inorganic ceramics.

3. Process according to claim 1 or 2, characterized in that at least one hydrogel element is designed as at least partial coating of the basic structure.

4. Process according to one of claims 1 to 3, characterized in that at least one hydrogel element is designed as a shaped body attached to the basic structure, the shaped body preferably being attached by at least partial embedding of an area of the basic structure into the shaped body.

5. Process according to one of claims 1 to 4, characterized in that the aqueous solution, aqueous liquid mixture or melt containing polyethylene oxide and/or polyethylene glycol is at least partly surrounded by film at the basic structure before irradiation.

6. Process according to claim 5, characterized in that the film is removed after irradiation.

7. Process according to one of claims 1 to 6, characterized in that areas of the basic structure are covered, before the application of the aqueous solution, aqueous liquid mixture or melt containing polyethylene oxide and/or polyethylene glycol, with an auxiliary coating which preferably contains a monomer, oligomer or polymer.

8. Process according to claim 7, characterized in that the aqueous solution, aqueous liquid mixture or melt containing polyethylene oxide and/or polyethylene glycol is applied to an area of the basic structure free from the auxiliary coating.

9. Process according to claim 7 or 8, characterized in that the auxiliary coating is removed after irradiation, preferably by alkaline hydrolysis, acid hydrolysis or the use of a solvent.

10. Process according to one of claims 1 to 9, characterized in that the aqueous solution, aqueous liquid mixture or melt contains a polyethylene oxide and/or polyethylene glycol with a molecular weight greater than 20,000, preferably greater than 100,000 and particularly preferably greater than 1,000,000.

11. Process according to one of claims 1 to 10, characterized in that at least one hydrogel element contains at least one substance selected from the following group: hydrophilic polymers, surfactants, saccharides, polysaccharides, polyvinyl alcohol, polyhydroxyethyl methacrylate, poly-n-isopropylacrylamide, polyvinylpyrrolidone; resorbable hydrophobic polymers, polyhydroxy acids, polylactide, polyglycolide, polyhydroxy butyric acids, polydioxanones, polyhydroxy valeric acids, polyorthoesters, polyphosphazenes, poly-ε-caprolactones, polyphosphates, polyphosphonates, polyurethanes, polycyanoacrylates, mixtures of the afore-mentioned substances, copolymers of the aforementioned substances.

12. Process according to one of claims 1 to 11, characterized in that the energy dose during irradiation is smaller than 100 kGy and is preferably in the range of 20 kGy to 30 kGy.

13. Process according to one of claims 1 to 12, characterized in that the irradiation is carried out with ⁶⁰Co-gamma radiation.

14. Process according to one of claims 1 to 13, characterized in that the implant is dried in the air.

15. Process according to one of claims 1 to 13, characterized in that the implant is dried by drying at the critical point.

16. Process according to one of claims 1 to 15, characterized in that the basic structure is designed as one of the shapes selected from the following group: mesh, tape, film tape, perforated film, circular-knitted tube, perforated tube, perforated pipe, stent.

17. Process according to one of claims 1 to 16, characterized in that the implant is designed as an implant selected from the following group: meshes for repairing hernias, tapes for supporting the middle urethra, stents, artificial vessels.

18. Process according to one of claims 1 to 17, characterized in that the basic structure contains a non-resorbable or a slowly resorbable polymer, the basic structure preferably containing at least one polymer selected from the following group: polyacrylates, polymethacrylates, polyacrylamides, polyethylenes, polypropylenes, polyvinyl acetates, polyethylene-co-vinyl acetates, polyureas, polyesters, polyether esters, polyamides, polyimides, polyamino acids, pseudopolyamino acids, terephtahlic acid-containing polyesters, partly fluorinated polyalkenes, perfluorinated polyalkenes, polyperfluoroethene, polyvinylidene fluoride, polycarbonates, polyarylether ketones, mixtures of the afore-mentioned substances, copolymers of the afore-mentioned substances.

19. Process according to one of claims 1 to 18, characterized in that the basic structure contains a resorbable polymer, the basic structure preferably containing at least one polymer selected from the following group: polyhydroxy acids, polylactide, polyglycolide, polyhydroxy butyric acids, polydioxanones, polyhydroxy valeric acids, polyorthoesters, polyphosphazenes, poly-ε-caprolactones, polyphosphates, polyphosphonates, polyurethanes, polycyanoacrylates, mixtures of the afore-mentioned substances, copolymers of the afore-mentioned substances.

20. Process according to one of claims 1 to 19, characterized in that at least one hydrogel element has a thickness in the range of 0.025 mm to 20 mm.

21. Process according to one of claims 1 to 20, characterized in that the basic structure is embedded at least regionally in at least one hydrogel element.

22. Process according to one of claims 1 to 21, characterized in that a basic structure designed as a piece of mesh is enclosed in hydrogel and is then connected to a conventional implant mesh, preferably sewn onto it.

23. Process according to one of claims 1 to 22, characterized in that at least one active ingredient, preferably selected from the following group: growth factors, cytostatics, antibiotics, hormones, heparin, growth inhibitors, antimycotics, antiphlogistics, gynaecological agents, urological agents, and/or at least one contrast agent, preferably selected from the following group: x-ray contrast agents, ultrasound contrast agents, near infrared contrast agents, magnetic resonance contrast agents, is introduced into at least one hydrogel element.

24. Process according to claim 23, characterized in that at least one contrast agent is enclosed in at least one hydrogel element.

25. Process according to claim 23 or 24, characterized in that at least one contrast agent and/or at least one active ingredient is releaseable in a controlled manner from at least one hydrogel element.
